(19) United States
(12) Patent Application Publication
(10) Pub. No.: US 2008/0155982 A1
(43) Pub. Date: Jul. 3, 2008

(54) Hydraulic Brake Master Cylinder

(76) Inventors: Christopher S. Jones, Milwaukee, WI (US); Jason Schuelke, Shorewood, WI (US); John L. Thomas, Cedarburg, WI (US); Richard Travis, Milwaukee, WI (US)

Correspondence Address: WHYTE HIRSCHBOECK DUDEK S C, 555 EAST WELLS STREET, SUITE 1900, MILWAUKEE, WI, 53202, US

(21) Appl. No.: 11/617,427

(22) Filed: Dec. 28, 2006

(51) Int. Cl. B60T 11/26

(52) U.S. Cl. 60/588; 248/309.2; 74/523

(57) ABSTRACT

A hydraulic brake master cylinder is provided that is compact and light in weight. The master cylinder has a reservoir shape that provides increased reservoir expansion volume. The master cylinder also provides gear shifter operation clearance and a comfortable lever that allows easy adjustment without the use of tools. The lever has defined increments of adjustment which make it easy to use. The invention also includes a method of bleeding air from the system without requiring reorientation of the master cylinder. The retention methods for the various lever embodiments shown allow for easy and inexpensive retention of the lever and also provide for reduced overall weight and cost.

### FIELD OF THE INVENTION

In general, the inventive arrangements relate to brakes and braking systems, and more specifically, to hydraulic brake master cylinders for bicycles or off-road vehicles.

### BACKGROUND OF THE INVENTION

The general operation of hydraulic brake master cylinders for bicycles or off-road vehicles is well known. The brake system includes a reservoir housing hydraulic fluid. The brake system operates by rotation of a lever which applies force to a piston. When force is applied, the piston slides in a longitudinal bore thereby producing an increase in hydraulic pressure in the bore which pressurizes the brake system. One or more fluid paths connect the piston bore to the reservoir. The reservoir contains a bladder that can expand and contract based on the needs of the system.

When the lever is in its free state, also known as the “home” position, its distance from the handlebar is typically adjustable. Current adjusters are difficult to use and levers typically cannot be adjusted without the use of tools, such as an allen wrench.

It is also critical to the bicycle industry to develop components that are smaller and lighter in weight. Reductions in the sizes, number of parts and weight of bike components, including the brake system, is advantageous since it reduces cost and overall weight. Reductions in weight enhance the appeal of the bike.

Bicycle master cylinders are sometimes symmetric and are typically located in close proximity to the gear shifter. Each bike rider has his or her own individual preference for the location of the gear shifter relative to the master cylinder lever. However, the shape of the master cylinder typically limits where the gear shifter may be located. It therefore is advantageous to reduce the size of the master cylinder, specifically in the area of gear shifter actuation, to provide more placement options for the location of the gear shifter relative to the master cylinder lever.

Another problem observed in the bike industry is the generation of high brake temperatures, especially during long descents. High brake temperatures expand the hydraulic fluid which requires compensation in the hydraulic fluid system. It is advantageous to make the reservoir expansion volume large enough to absorb all possible fluid expansion in the brake system.

Another problem encountered by the bicycle manufacturing industry is to provide for the easy removal of air from the hydraulic system by bleeding. Bleeding air from the system can be difficult. Additionally, reorientation of the master cylinder is generally required. Some systems require removal of the reservoir cover and bladder to access the fluid. If a bleeder screw is used for bleeding purposes, it typically has an elastomeric seal that requires special geometry in the reservoir or bladder. It would therefore be advantageous to incorporate a bleeder screw that doesn't require an elastomeric seal or special reservoir and bladder geometry located in a position where reorientation of the master cylinder during bleeding is not required.

As described, it is desirable to provide a substantially symmetric hydraulic brake master cylinder that is compact, light in weight, sculpted around the gear shifter, with reduced part numbers, sufficient fluid expansion capacity in the reservoir, and which provides for tool free adjustment of the lever, as well as a comfortable lever to use. Additionally, it is advantageous to improve the bleeding process by utilizing low cost bleeder screws located where reorientation of the master cylinder is not required.

### SUMMARY OF THE INVENTION

It is an object of the present invention to provide a master cylinder for a hydraulic brake master cylinder for a bicycle that is compact and light.

It is also an object of the invention to provide a hydraulic brake master cylinder that has a reservoir shape which provides the necessary fluid volume as well as large expansion volume.

It is a further object of the invention to provide a substantially symmetric hydraulic brake master cylinder that provides gear shifter operation clearance.

It is also an object of the invention to provide a lever that has been sculpted to provide comfort throughout its stroke.

It is a further object of the invention to provide an adjustment mechanism that allows for the modification of the lever home position without the use of tools.

It is another object of the invention to provide defined increments of adjustment to the lever home position for further ease of use.

It is an object of the invention to provide a lever having defined increments of adjustment through use of a pivot pin that is symmetric and utilizes low cost retention.

It is a further object of the invention to provide a lever having a split end which allows for retention by a single, inexpensive clip.

It is another object of the invention to provide a body having a single flange to which the split end of the lever is retained, allowing for reduced weight.

It is also an object of the invention to provide for the removal of air from the brake system by bleeding without requiring reorientation of the master cylinder.

Various other features, objects and advantages of the present invention will become apparent to one of ordinary skill in the art from the following detailed description taken together with the drawings.

### BRIEF DESCRIPTION OF THE DRAWINGS

Preferred embodiments of the invention are described below with reference to the following drawings, which are provided for illustrative purposes only. The drawings illustrate a best mode contemplated for caring out the invention. In the drawings:

FIG. 1 is an exploded view of the master cylinder;

FIG. 2 is a front view of the master cylinder;

FIG. 3 is a sectional view of the master cylinder taken along line 3-3 of FIG. 2;

FIG. 4 is a rear view of the master cylinder;

FIG. 5 is a profile view of the master cylinder;

FIG. 6 is a sectional view taken along line 6-6 of FIG. 5;

FIG. 7 is an exploded detail view of the adjuster;

FIG. 8 is a side view of the master cylinder;

FIG. 9 is a sectional view taken along line 9-9 of FIG. 8;

FIG. 10 is a detail area view taken along line 10-10 of FIG. 9;

FIG. 11 is a plan view of the lever;

FIG. 12 is a sectional view taken along line 12-12 of FIG. 11;

FIG. 13 is a sectional view taken along line 13-13 of FIG. 12;

FIG. 14 is an exploded view of a second embodiment of the master cylinder;

FIG. 15 is a front view of the second embodiment shown in FIG. 14;

FIG. 16 is a sectional view taken along line 16-16 of FIG. 15;

FIG. 17 is a plan view of the second embodiment shown in FIG. 14;

FIG. 18 is a detail view of the pin of the second embodiment shown in FIG. 14;

FIG. 19 is an end view of the pin of the second embodiment shown in FIG. 14;

FIG. 20 is a plan view of the lever in the second embodiment shown in FIG. 14;

FIG. 21 is a sectional view taken along line 21-21 of FIG. 20;

FIG. 22 is an exploded view of a portion of the third embodiment of the master cylinder;

FIG. 23 is a front view of the third embodiment of the master cylinder;

FIG. 24 is a sectional view taken along line 24-24 of FIG. 23;

FIG. 25 is a front view of the fourth embodiment of the master cylinder;

FIG. 26 is a sectional view taken along line 26-26 of FIG. 25;

FIG. 27 is a plan view of the fourth embodiment of the master cylinder;

FIG. 28 is a rear view of the body in a fifth embodiment of the master cylinder; and

FIG. 29 is a profile view of the body in a fifth embodiment of the master cylinder as shown in FIG. 28.

Before explaining embodiments of the invention in detail, it is to be understood that the invention is not limited in its application to the details of construction and the arrangement of the components set forth in the following description or illustrated in the drawings. The invention is capable of other embodiments or being practiced or carried out in various ways. Also, it is to be understood that the phraseology and terminology employed herein is for the purpose of description and should not be regarded as limiting.

### DETAILED DESCRIPTION OF THE PREFERRED EMBODIMENT

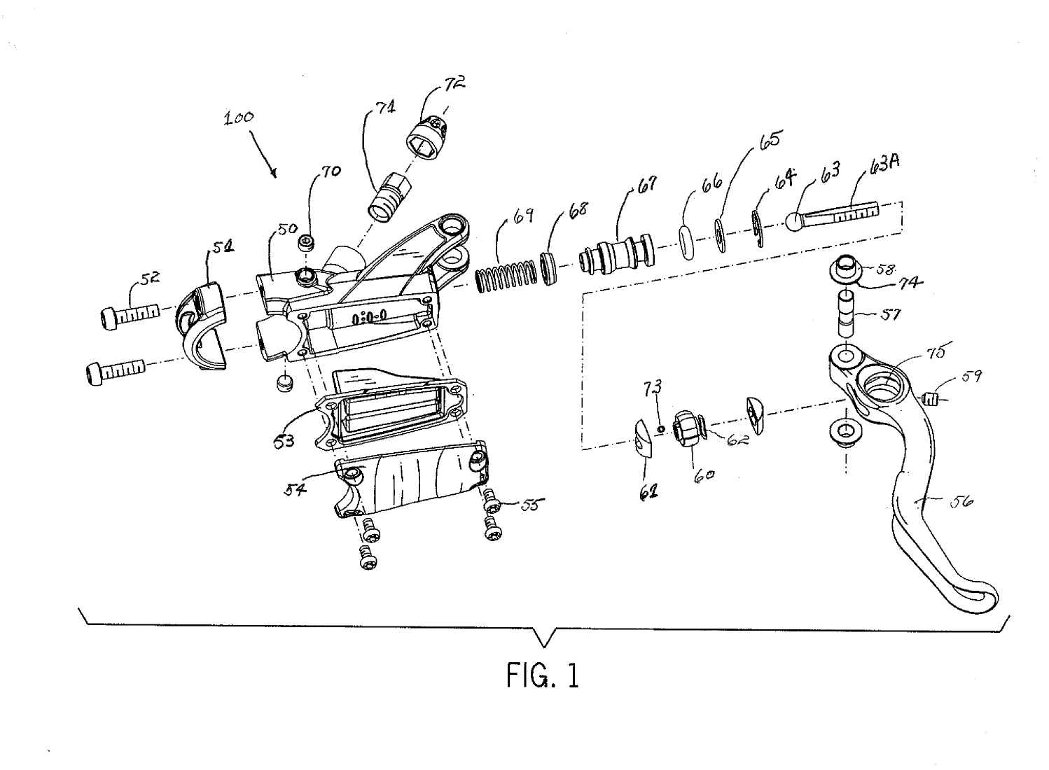

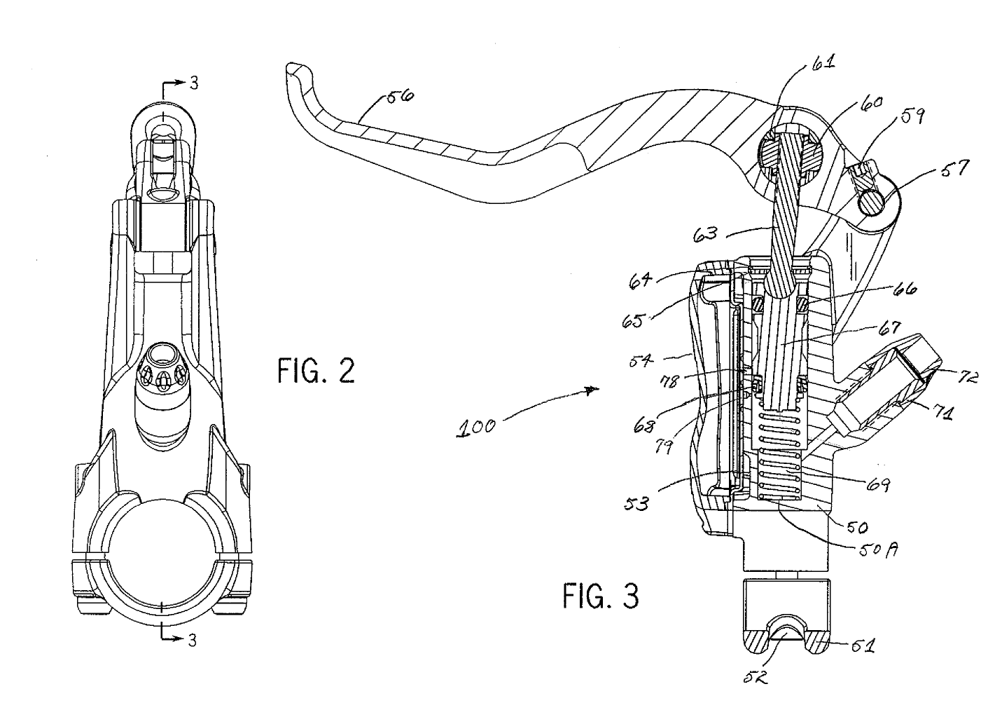

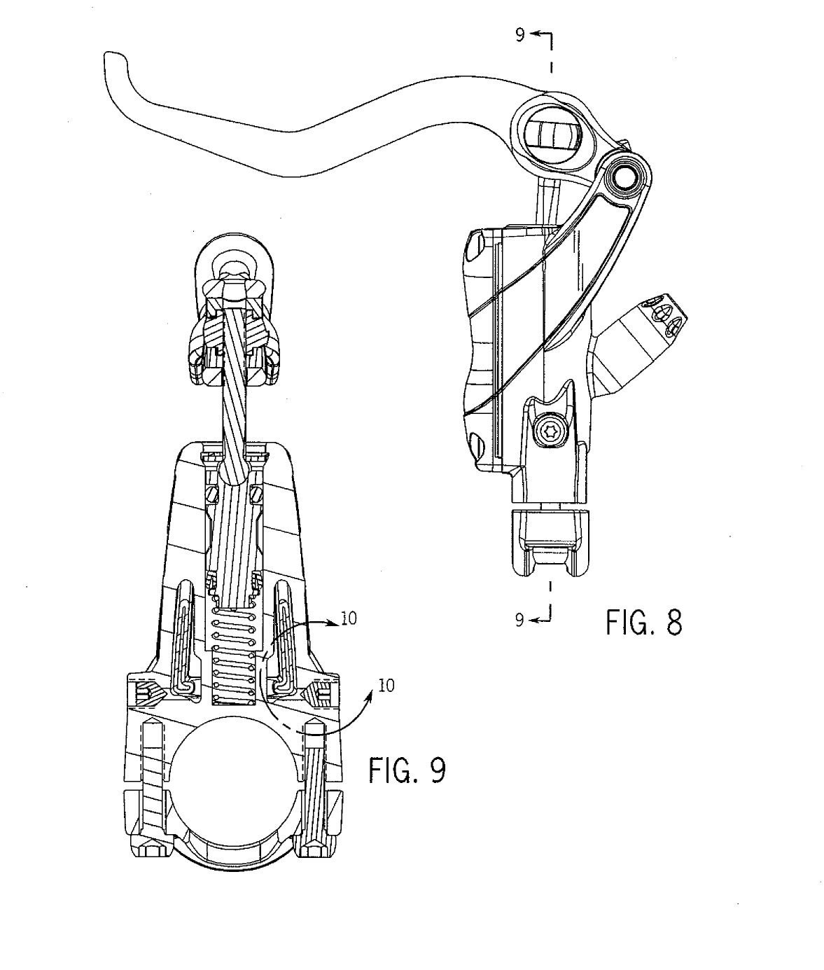

In FIGS. 1-13, a first embodiment of a hydraulic brake master cylinder assembly 100 is shown. A body 50 is attached to a handlebar (not shown) on a bicycle or off-road vehicle by means of a clamp 51 and clamp screws 52. A bladder 53 is fixed to the body 50 by a reservoir cap 54 and reservoir cap screws 55. The space between the bladder 53 and the body 50 defines the reservoir fluid volume, while the space between the bladder 53 and the reservoir cap 54 defines the reservoir expansion volume.

A lever 56 is pivotally attached to the body 50 by a pivot pin 57 and set screw 59. The pivot pin 57 is necked down towards the center so that it cannot be removed when the set screw 59 is installed. The pivot pin 57 rotates relative to the body 50 on pivot pin bushings 58. The pivot pin bushings 58 each have a flange 74 that keep them retained once the pivot pin 57 is installed and allow the lever 56 to rotate smoothly.

A pushrod 63 is pivotally attached to the lever 56 by means of an adjuster nut 60, adjuster bushings 61, and spring washer 62. One end of the pushrod 63 is a sphere and is engaged in a spherical pocket in the piston 67. A retaining ring 64 fits within a groove in the body 50 and retains a washer 65 which contains a hole having a diameter smaller than that of the spherical end of the pushrod 63. Once installed, the retaining ring 64 and washer 65 define an end stop for the pushrod 63.

The pushrod 63 is engaged with the adjuster nut 60 by threads. There are flat surfaces 63A on the pushrod 63 and corresponding flat surfaces on the adjuster bushings 61. The exterior of the adjuster bushings 61 are cylindrical and fit within a cylindrical pocket 75 in the lever 56. As seen in FIG. 7, the adjuster nut 60 also contains cylindrical protrusions 60A at each end coaxial to the threaded portion, the cylindrical protrusions 60A being supported by corresponding pockets 61B in the adjuster bushings 61. The adjuster bushings 61 each contain a pocket 61A which receives a detent spring 73 that reacts against surface interruptions in the cylindrical protrusions 60A. As the adjuster nut 60 is rotated, the pushrod 63 is prevented from rotating by the flat surfaces 61C and cylindrical exterior of the adjuster bushings 61 and therefore the adjuster nut 60 travels axially relative to the pushrod 63. As the adjuster nut 60 is rotated, the detent spring 73 engages in the surface interruptions in the cylindrical protrusion 60A of the adjuster nut 60, providing distinct adjustment increments. As the adjuster nut 60 travels, it pivots within the lever 56, forcing the lever 56 to rotate relative to the body 50 on the pivot pin 57, and thus modifying the “home” position.

An alternative embodiment for adjustment in defined increments to the mechanism of the detent spring 73 described herein is to place a detent ball 88 with the detent spring 73 into the cavity in the adjuster nut 60 where the detent ball 88 is forced by the detent spring 73 into surface interruptions in the adjuster bushings 61 to provide defined increments of adjustment.

The piston 67 has an elastomeric primary seal 68 and secondary seal 66. A spring 69 is fit at one end to the piston 67 and at the other end to the piston bore bottom 50A in the body 50. The volume of the piston bore 76 between the piston bore bottom 50A and the primary seal 68 defines a first chamber and the area between the primary seal 68 and secondary seal 66 defines a second chamber. The primary seal 68 allows fluid to flow from the second chamber to the first chamber but no flow is allowed in the reverse direction. The secondary seal does not allow any fluid passage.

When the lever 56 is released, the spring 69 pushes the piston 67 and pushrod 63 against the backstop of the washer 65 and retaining ring 64. This is the initial position of the piston 67. At this position, one or more port timing holes 79 are in the body 50 connecting the first chamber to the reservoir fluid volume. A compensating port 78 is located in the body 50 between the second chamber and the reservoir fluid volume throughout the piston 67 stroke range. A port on the body near the piston bore bottom 50A communicates any pressure in the first chamber to the brake system.

When the lever 56 is rotated relative to the body 50 (towards the handlebar), the pushrod 63 pushes the piston 67 towards the piston bore bottom 50A which compresses the spring 69. Once the primary seal 68 has passed the port timing hole 79, pressure is generated in the first chamber and transmitted to the brake hose (not shown) which is connected to the body by a compression nut 71 and then covered by a nose cone 72 (see FIG. 3).

If the brake fluid expands due to heat generated during braking, in the initial position of the piston 67, fluid will flow through the port timing holes 79 and into the reservoir fluid volume. The bladder 53 will deform into the reservoir expansion volume and thus increase the size of the reservoir fluid volume.

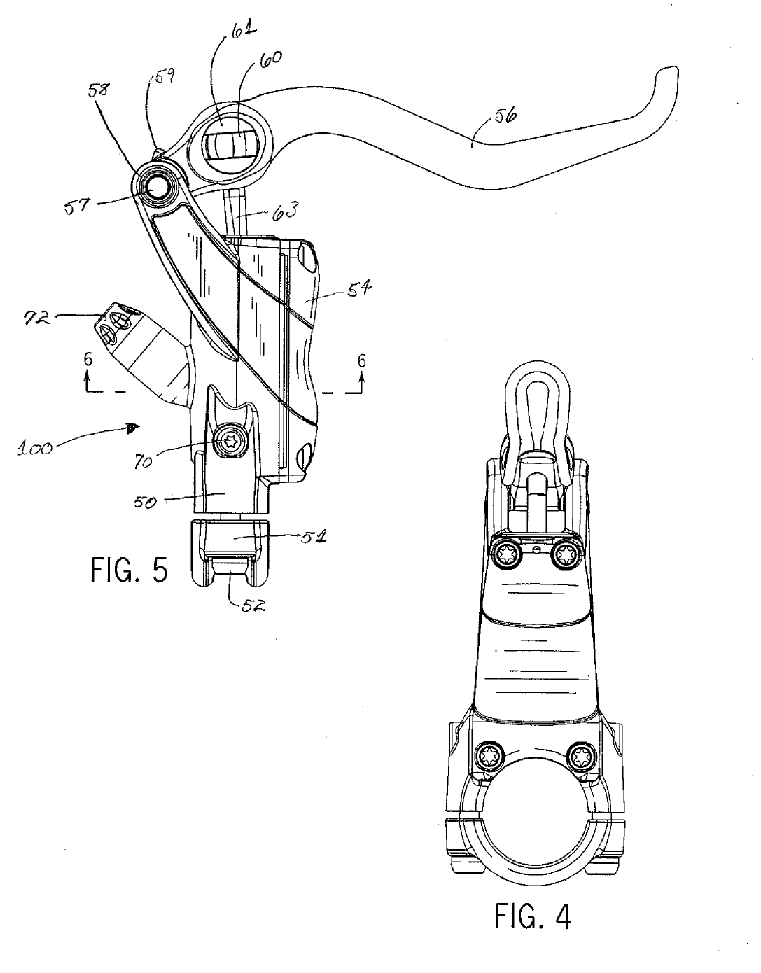

In FIG. 4, the reservoir shape near the handlebar can be seen. By wrapping the reservoir cavity in the body 50, the bladder 53, and the reservoir cap 54 around the handlebar, a larger reservoir fluid volume and reservoir expansion volume is created in a compact package. In FIG. 5, the profile shape of the reservoir cap 54 can be seen. By adding the concave shape towards the center of the reservoir cap 54 for gear shifter operation clearance, a larger reservoir expansion volume is created near the ends of the reservoir cap 54.

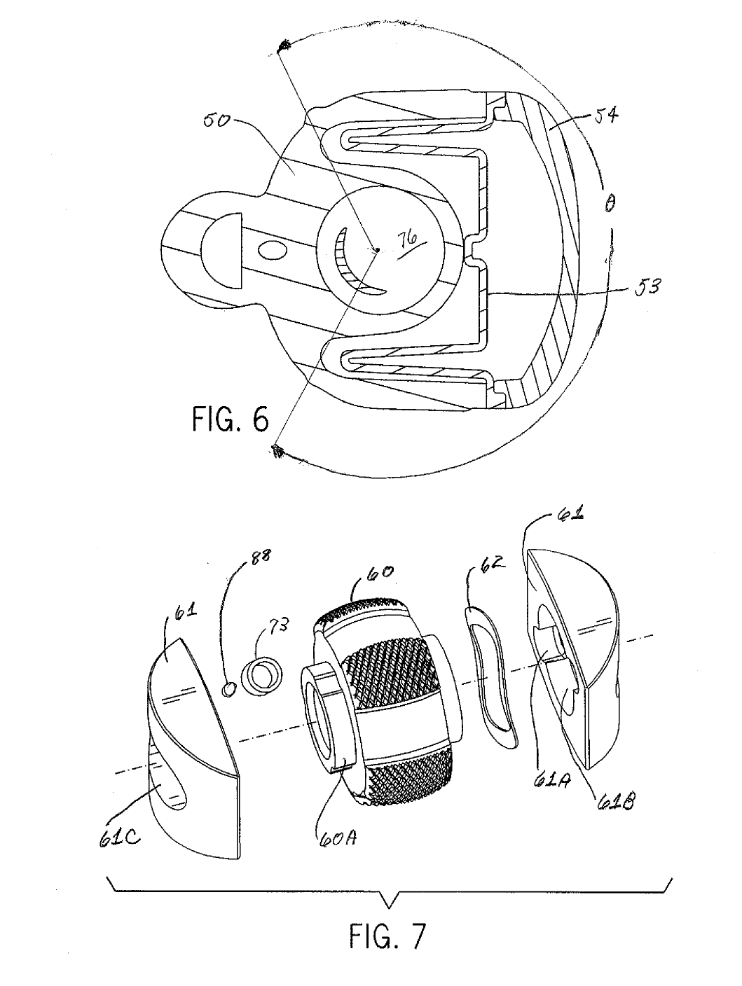

In FIG. 6, a section of the reservoir is shown. By wrapping the reservoir fluid volume area more than 180 degrees (angle θ) around the exterior of the piston bore 76, a larger reservoir fluid volume is created in a compact package.

It has been found through testing that a reservoir expansion volume of at least 2.5 cc is preferred, although not necessary. By including the features described herein, an expansion of more than 2.5 cc is achieved without an undesirable effect on the gear shifter position relative to the hydraulic brake master cylinder 100. Of course, other desirable effects can be achieved by obtaining a ratio of reservoir expansion volume to reservoir fluid volume in the system. Preferably, this ratio is at least 1.8 and this ratio is achieved through the invention. However, other ratios could be beneficial and are intended to be included herein.

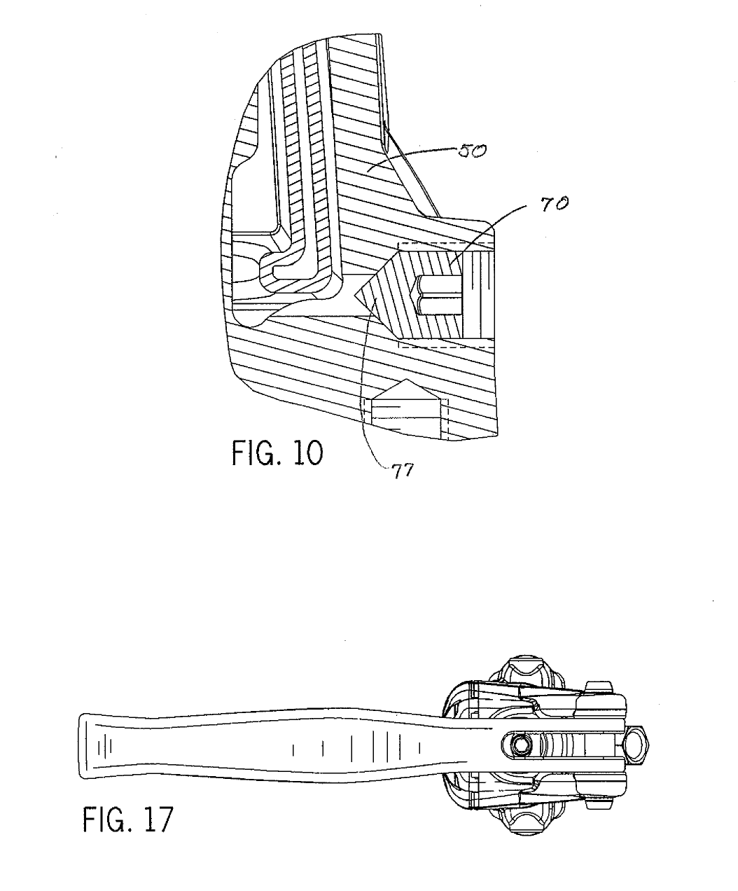

In FIG. 10, detail of the bleeder screw 70 installation can be seen. The bleeder screw 70 is engaged to a bleeder port in the body 50 by threads. The bleeder screw nose 77 is tapered and deforms the material in the bleeder port of the body 50 when installed, creating a low pressure fluid seal. The location of the bleeder port is on both sides of the body near the handlebar near the piston bore centerline in the reservoir fluid volume when viewed from the side (see bleeder screw 70 in FIG. 5). This allows for simplified bleeding of the system without reorientation of the master cylinder 100.

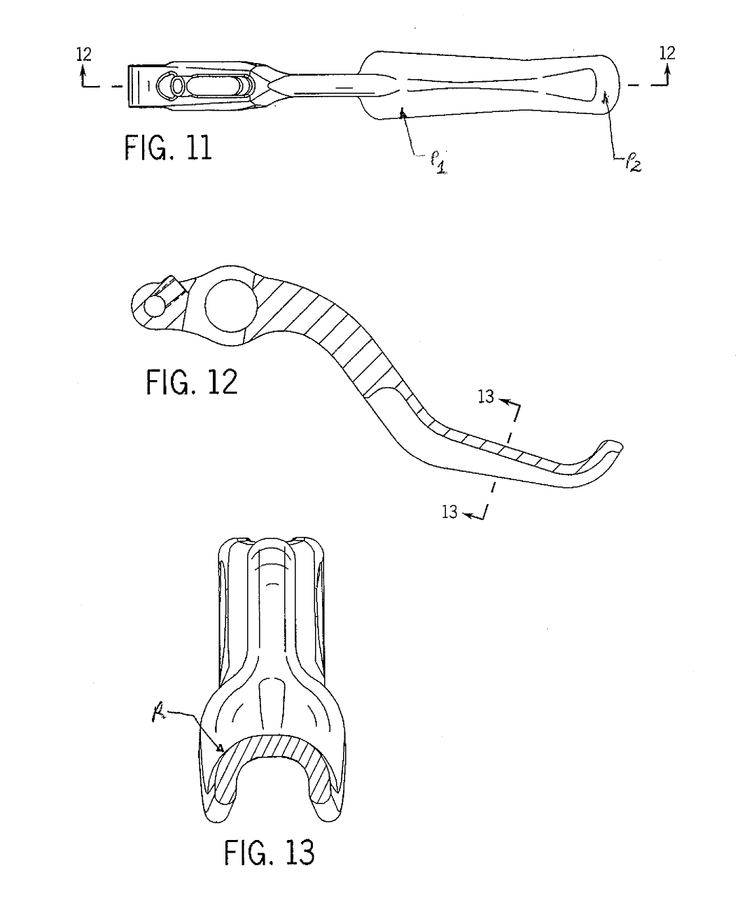

FIGS. 11-13 show the detail of the finger contact area of the lever 56. In FIG. 11, an hourglass shape of the finger contact area is described. In a preferred embodiment, the shape narrows in width from approximately 13.5 mm at the tip to approximately 11.5 mm near the first finger contact and then increases to approximately 15.5 mm near the inner end of the finger contact area. However, other sizes and tapering are possible and are intended to be included herein.

As shown in FIG. 12, the finger contact area profile in a preferred embodiment has a fillet of approximately 8 mm near the tip and 12.5 mm near the inner end. The length between the fillet tangents is ideally approximately 25 mm. A flange at the tip is approximately 8.5 mm high in the preferred embodiment, thereby enhancing lever comfort for the user. FIG. 13 shows a radius R that runs along the perimeter of the finger contact area. This radius tapers from approximately 6.5 mm at point P1 (FIG. 11) to approximately 2.5 mm at point P2 (FIG. 11). The shape of the finger contact area described above results in increased comfort for the user. However, the shape and amount of tapering can vary in degree and variations thereof are intended to be encompassed herein.

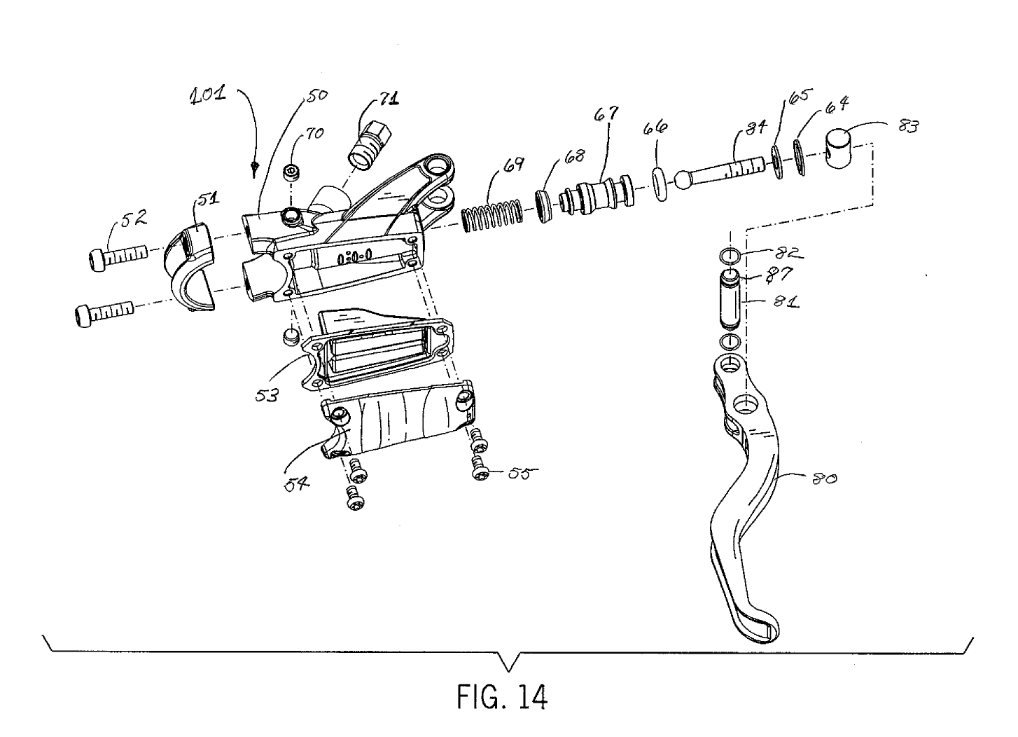

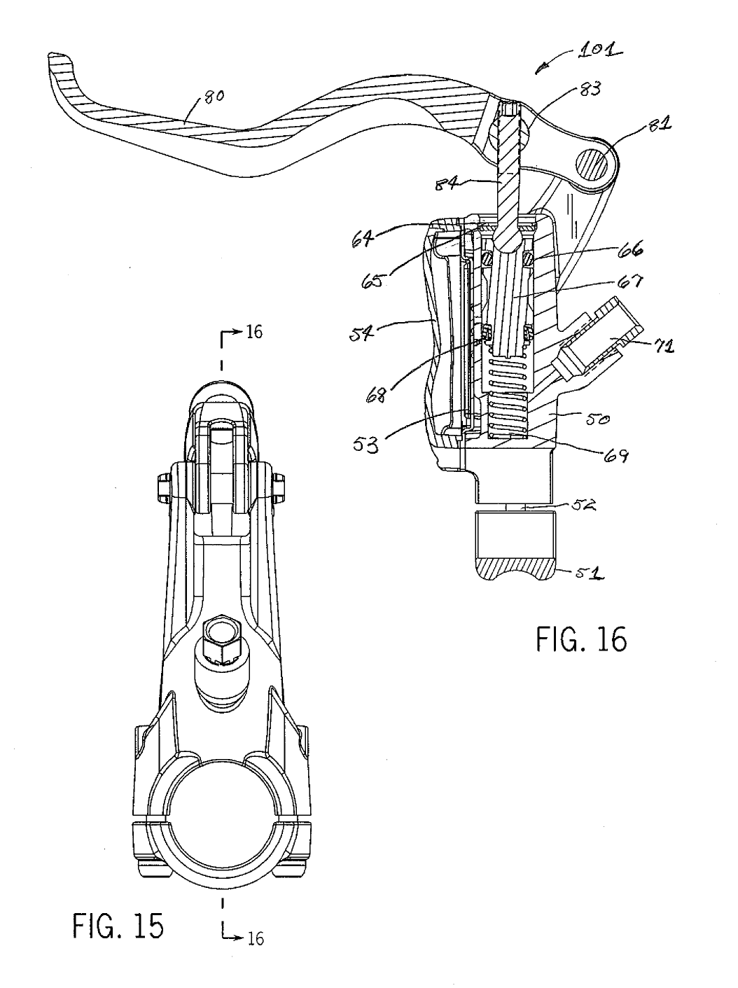

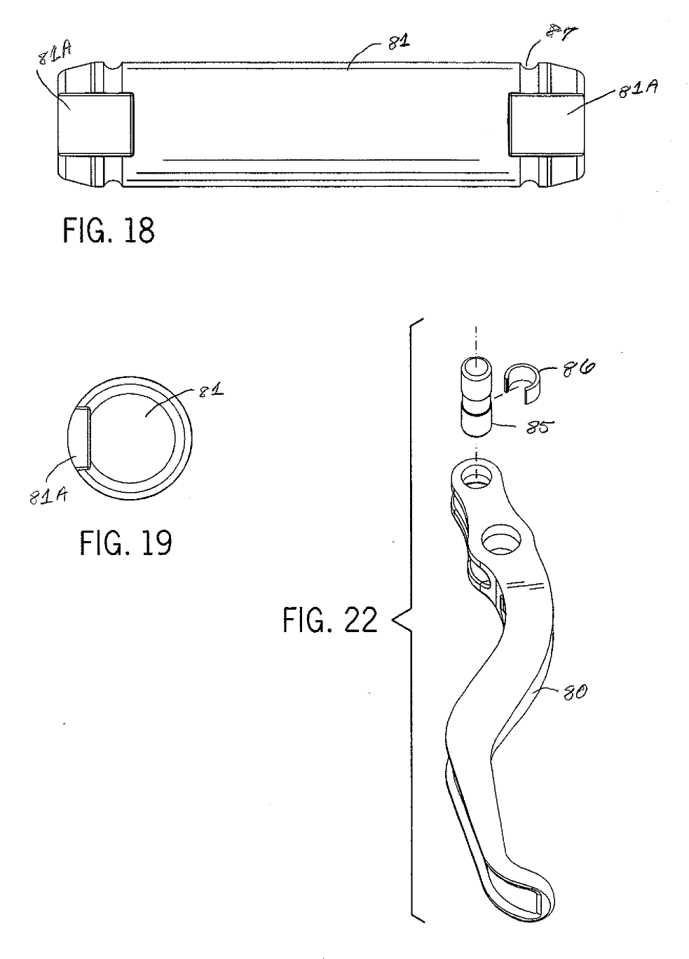

A second embodiment of the hydraulic brake master cylinder 101 is shown in FIGS. 14-21. In this embodiment, the lever 80 is pivotally attached to the body 50 by a pivot pin 81. FIGS. 18-19 show details of the pivot pin 81. The pivot pin 81 is symmetrical and has a concave pivot pin groove 87 around the circumference at each end to which a clip 82 is installed, thereby retaining the pivot pin 81 to the body 50. Each end of the pivot pin 81 has a relief 81A (shown in FIG. 18) which allows for a tool such as a screwdriver to be inserted for easy removal of the clips 82. The pushrod 84 is attached to an adjuster bushing 83 by threads. The adjuster bushing 83 pivots within the lever 80. The remainder of the components of the hydraulic brake master cylinder 101 are as described in the first embodiment.

To adjust the home position of the lever 80, the pushrod 84 is rotated. The adjuster bushing 83 has a cylindrical exterior contained in a corresponding hole in the lever 80 which prevents it from rotating and thus the adjuster bushing 83 moves axially relative to the pushrod 84. As the adjuster bushing 83 travels, it pivots within the lever 80, thereby forcing the lever to rotate relative to the body 50 on the pivot pin 81 and thus modifying the home position.

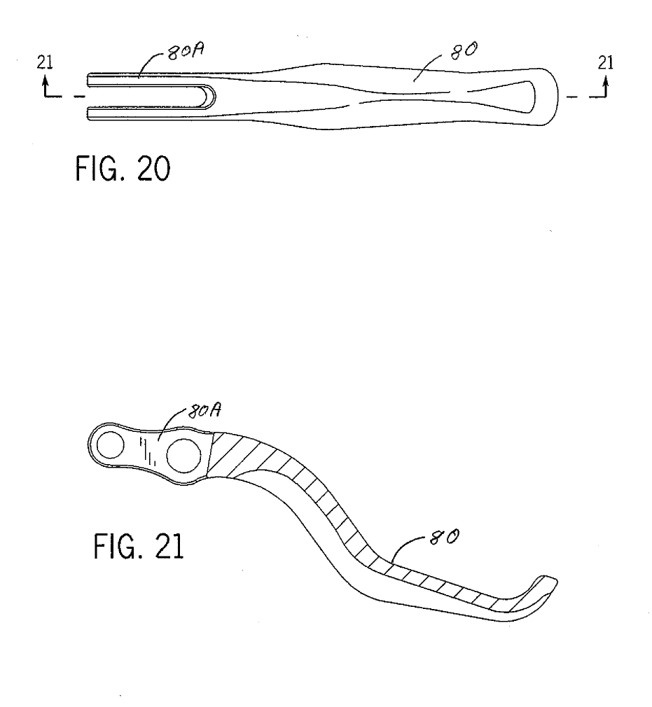

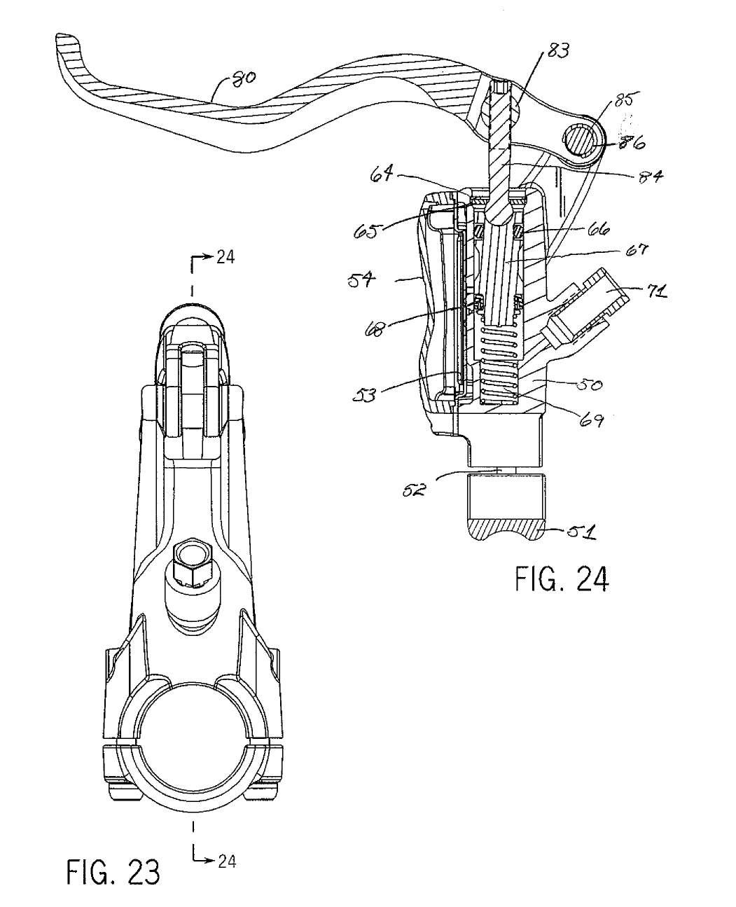

A preferred embodiment of the lever 80 is shown in FIGS. 20-21. The end of the lever 80 that accepts a pivot pin 81 and an adjuster bushing 83 is split into two legs 80A. In a third embodiment, as shown in FIGS. 22-24, the end of the lever 80 is pivotally attached to the body 50 by a pivot pin 85 and clip 86. The clip 86 is located between the lever legs 80A. This arrangement allows for a reduced number of parts as well as reduced weight and improved appearance.

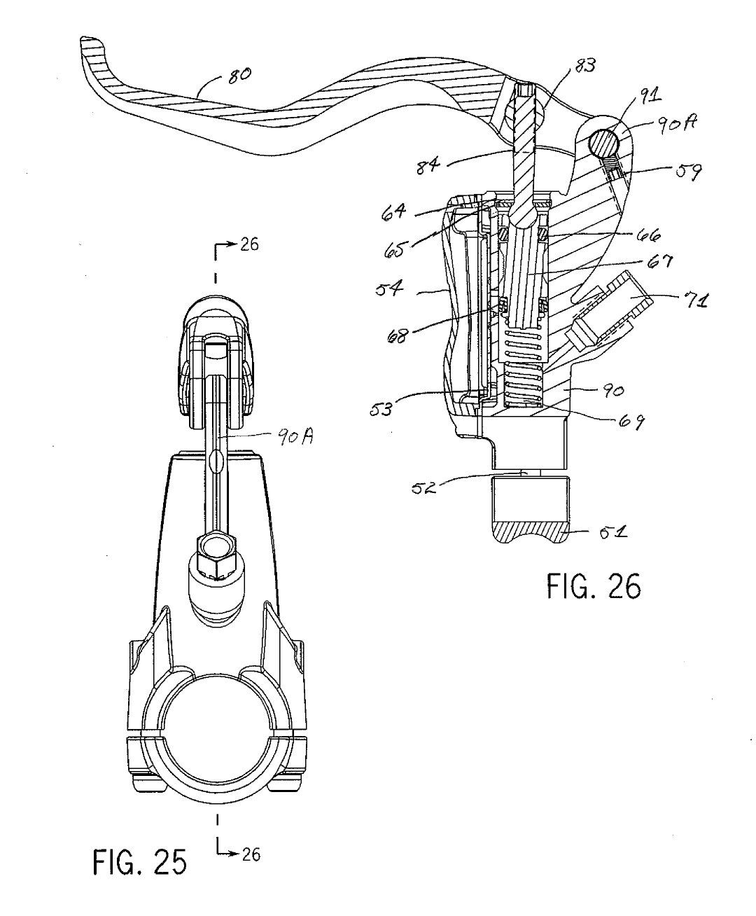

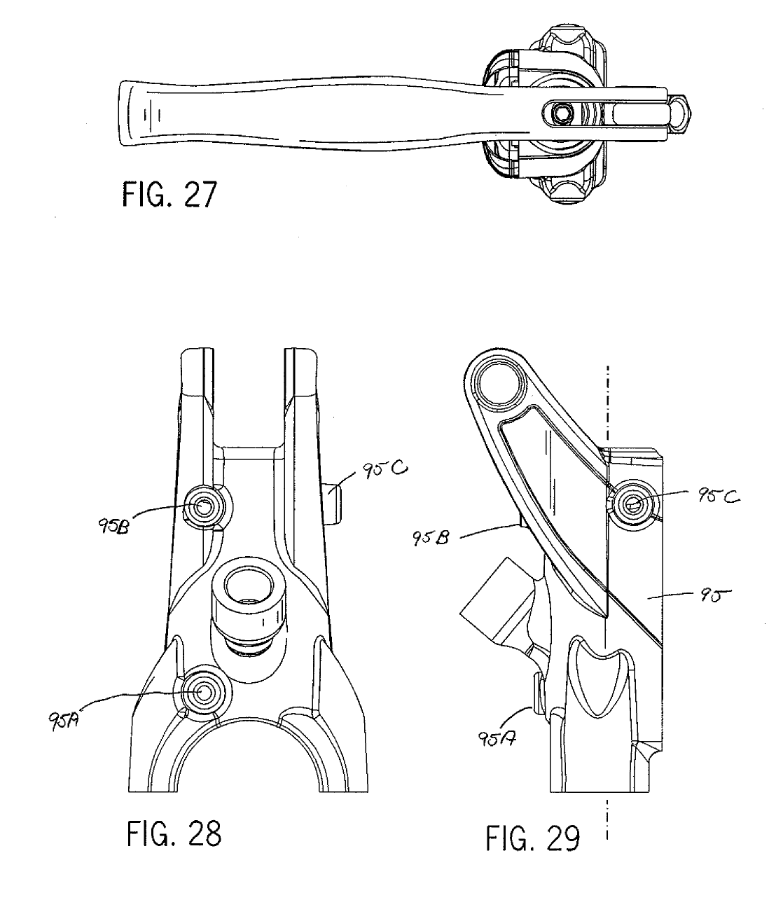

FIGS. 25-27 show a fourth embodiment utilizing the split end of lever 80. The body 90 has single flange 90A that supports the pivot pin 91 and lever 80 between the lever legs 80A. The pivot pin 91 is necked down towards the center so that it cannot be removed when the set screw 59 is installed. This arrangement allows for reduced weight, a reduced number of parts, and improved appearance.

A fifth embodiment is shown in FIGS. 28-29. Here, the body 95 has alternate bleed port locations. The first bleed port 95A is located on the back of the body 95 opposite the reservoir cap 54 near the handlebar in the reservoir fluid area. The second bleed port 95B is located on the back of the body 95 opposite the reservoir cap 54 in the reservoir fluid area furthest from the handlebar. The third bleed port location 95C is located on the side of the body 95 near the piston bore centerline (as shown) in the reservoir fluid area furthest from the handlebar. These alternate locations do not require special reservoir or bladder geometry.

It is understood that the various preferred embodiments are shown and described above to illustrate different possible features in the invention and the varying ways these features may be combined. Apart from combining the different features of the above embodiments and varying ways, other modifications are also considered to be within the scope of the invention.

The invention is not intended to be limited to the preferred embodiments described above, but rather is intended to be limited only by the claims setout below. Thus, the invention encompasses all alternate embodiments that fall literally or equivalently within the scope of these claims.

What is claimed is:

1. A hydraulic brake master cylinder having:
a cylindrical internal bore; and
a reservoir partially surrounding the cylindrical internal bore, wherein the reservoir contains a reservoir fluid volume and reservoir expansion volume and further wherein the reservoir surrounds more than 180 degrees of the cylindrical internal bore.

2. A hydraulic brake master cylinder for a bicycle or off-road vehicle having a handlebar wherein:
the hydraulic brake master cylinder has a reservoir partially formed around the handlebar.

3. A hydraulic brake master cylinder for a bicycle or off-road vehicle having a gear shift wherein:
the hydraulic brake master cylinder has a reservoir with a reservoir cover; and
the reservoir cover has a concave portion to provide clearance for the operation of the gear shift.

4. A hydraulic brake master cylinder having:
a reservoir containing a reservoir fluid volume and a reservoir expansion volume, wherein the reservoir expansion volume has an air volume of at least 2.5 cc.

5. A hydraulic brake master cylinder having a reservoir containing a reservoir fluid volume and a reservoir expansion volume, wherein the ratio of reservoir expansion volume to reservoir fluid volume is at least 1.8.

6. A hydraulic brake master cylinder for a bicycle or off-road vehicle having a handlebar, wherein the hydraulic brake master cylinder has:
a reservoir containing a reservoir fluid volume and a reservoir expansion volume;
a piston bore having a centerline; and
at least one bleeder port;
and further wherein, at least one of the bleeder ports is located near the piston bore centerline, near the handlebar and in the reservoir fluid volume when viewed from the side.

7. The hydraulic brake master cylinder of claim 6 further having a lever with a centerline along the length thereof wherein the hydraulic brake master cylinder is substantially symmetric along the lever centerline and a bleeder port is located on opposite sides of the master cylinder.

8. A hydraulic brake master cylinder for a bicycle or off-road vehicle having a handlebar, wherein the hydraulic brake master cylinder has:
a reservoir having a reservoir fluid volume and a reservoir expansion volume;
a piston bore having a centerline; and
at least one bleeder port;
and further wherein, at least one of the bleeder ports is located near the piston bore centerline, and in the reservoir fluid volume area furthest from the handlebar when viewed from the side.

9. The hydraulic brake master cylinder of claim 8 further having a lever with a centerline along the length thereof, wherein the hydraulic brake master cylinder is substantially symmetric along the lever centerline and a bleeder port is located on opposite sides of the master cylinder.

10. A hydraulic brake master cylinder for a bicycle or off-road vehicle having a handlebar, wherein the hydraulic brake master cylinder has:
a reservoir containing a reservoir fluid volume and a reservoir expansion volume;
a reservoir cap; and at least one bleeder port wherein a bleeder port is located on the back side of the hydraulic brake master cylinder opposite the reservoir cap, near the handlebar, and in the reservoir fluid volume area.

11. The hydraulic brake master cylinder of claim 10 further having a lever with a centerline along the length thereof, wherein the hydraulic brake master cylinder is substantially symmetric along the lever centerline and a bleeder port is located on opposite sides of the hydraulic brake master cylinder.

12. A hydraulic brake master cylinder for a bicycle or off-road vehicle having a handlebar, wherein the hydraulic brake master cylinder has:
a reservoir containing a reservoir fluid volume and reservoir expansion volume;
a reservoir cap;
at least one bleeder port; and
wherein a bleeder port is located on the back of the hydraulic brake master cylinder, opposite the reservoir cap, at the furthest location from the handlebar, and in the reservoir fluid volume area.

13. The hydraulic brake master cylinder of claim 12, further having a lever with a centerline along the length thereof, wherein the hydraulic brake master cylinder is substantially symmetric along the lever centerline and a bleeder port is located on opposite sides of the master cylinder.

14. A hydraulic master cylinder having:
a bleeder screw with a tapered nose and a body bleeder port, wherein the tapered nose deforms material in the body bleeder port upon installation to create a low pressure seal.

15. A home position adjustment mechanism for a lever having a cylindrical hole there-through comprising:
a threaded adjuster nut;
a threaded pushrod having one or more flat surfaces;
an adjuster bushings fitting within the cylindrical hole in the lever wherein the adjuster bushings fitting has a hole with flat surfaces corresponding to those of the pushrod; and
a detent spring, such that the threaded adjuster nut travels axially along the pushrod as the adjuster nut is rotated and pivots within the lever.

16. The home position adjustment mechanism of claim 15 further comprising an elastomeric member, wherein the adjuster nut has surface interruptions to provide defined increments of adjustment.

17. The home position adjustment mechanism of claim 16 where the elastomeric member is a spring.

18. The home position adjustment mechanism of claim 16 where the elastomeric member is rubber tubing.

19. The home position adjustment mechanism of claim 15 further having a detent ball in combination with the detent spring wherein the adjuster bushings have surface interruptions and wherein the detent ball is forced by the detent spring into the surface interruptions in the adjuster bushings to provide defined increments of adjustment.

20. A lever, having a finger contact area comprising an hourglass shape when viewed from the top.

21. A lever having a finger contact area with a perimeter, wherein there is a fillet around the perimeter of the finger contact area having an inside end and a tip, wherein the fillet tapers from a larger width at the inside end of the finger contact area to a smaller width at the tip.

22. A symmetrical cylindrical pivot pin with two ends, having concave grooves around its circumference near each of the two ends to accept a simple wire form clip.

23. The symmetrical pivot pin of claim 22 having a relief at each end to accept a tool for easy clip removal.

24. A lever having an attachment end wherein the attachment end is split into two lever legs.

25. A hydraulic brake master cylinder containing the lever of claim 24 and further having a pivot pin attachment; wherein the pivot pin is retained by a clip fitting between the lever legs.

26. A hydraulic brake master cylinder containing the lever of claim 24 wherein the hydraulic brake master cylinder has a single flange between the lever legs to support the lever and pivot pin.

27. The hydraulic brake master cylinder of claim 26 further containing a pivot pin with a necked down portion at the center thereof and a set screw contained within the body flange to fix the pivot pin location.
